(19) United States
(12) Patent Application Publication
(10) Pub. No.: US 2024/0218971 A1
(43) Pub. Date: Jul. 4, 2024

(54) OIL CIRCUIT DESIGN, OIL SUPPLY METHOD AND DOUBLE CIRCUIT OIL PUMP FOR WHEEL END ELECTRIC DRIVE AXLE LUBRICATION

(71) Applicant: ZF Friedrichshafen AG, Friedrichshafen (DE)

(72) Inventors: Feng HU, Jiaxing City (CN); Jun GU, Jiaxing City (CN); Thomas Auer, Passau (DE)

(73) Assignee: ZF Friedrichshafen AG, Friedrichshafen (DE)

(21) Appl. No.: 18/396,831

(22) Filed: Dec. 27, 2023

(30) Foreign Application Priority Data
Dec. 28, 2022 (CN) 202211693543.7

(51) Int. Cl. F16N 7/38; F04D 25/06; F04D 25/16; F04D 29/10; F16N 7/40; F16N 13/20; F16N 39/02; F16N 39/06; H02K 9/22

(52) U.S. Cl. CPC F16N 7/385; F04D 25/06; F04D 25/163; F04D 29/106; F16N 7/40; F16N 13/20; F16N 39/02; F16N 39/06; H02K 9/22; F16N 2210/04; F16N 2210/18

(57) ABSTRACT

Disclosed are an oil circuit, an oil supply method for lubricating wheel-end electric drive axles, and a dual-circuit oil pump. The oil pump has a motor, first and second pumps with a common rotor shaft driven by the motor, and a seal mounted on the rotor shaft and configured to sealingly isolate the first pump from the second pump. The oil circuit design includes an oil pump, first and second oil filters, and first and second heat exchangers. From first and second housings each receiving a first and second wheel-end electric drive axle, respectively, a lubricating oil flows into a respective oil filter, flows into the oil pump after being filtered, is then pumped into the respective heat exchanger and cooled, and finally flows back into the respective housing.

### TECHNICAL FIELD

The present invention relates to the technical field of wheel-end electric drive axles, and in particular to an oil circuit design and an oil supply method for lubricating wheel-end electric drive axles, and a dual-circuit oil pump.

### BACKGROUND ART

In electric vehicles, the use of wheel-end electric drives can improve the overall vehicle space utilization rate by moving driving units into wheel rims. The wheel-end electric drive means that an electric motor is mounted to a wheel end to drive the wheel independently.

There are some cases for distributing the wheel-end electric drives.

\textcircled{1} Two water coolant motors have separate speed reducers. In this case, only a coolant needs to cross on two sides and all water channels are filled with the coolant.

\textcircled{2} Two electric motors share oil cooling. In this case, oil cannot completely fill the area that needs to be cooled, and gravity thus has a strong impact on the oil distribution on two sides due to the long horizontal distance between the two electric motors. Therefore, the solutions on the market are as follows: 1) some manufacturers provide independent cooling and lubrication on two sides in some products; and 2) non-independent cooling is performed on two sides, but the non-independent cooling on the two sides cannot support the electric drive axles for a long time, and cannot support the large inclination of the electric drive axles.

When a commercial vehicle travels in a tilting manner (for example, when a commercial vehicle travels across a slope), uneven oil distribution is likely to occur due to the height difference between the motors at two ends, resulting in an increase in motor power loss.

### SUMMARY OF THE INVENTION

In view of this, an objective of the present invention is to solve the lubrication problem of a wheel-end electric drive system in a commercial vehicle and improve the system efficiency.

The present invention provides a trade-off (compromised) solution. Compared with independent solution 1) above, the oil pump is simpler and the oil circuit is not complicated, and the use of all the oil in the system can be maximized without being too expensive. Compared with non-independent solution 2) above, this trade-off solution can achieve all the advantages of independent solution 1), but the cost will not increase too much.

In order to achieve the above objective, the present invention provides an oil circuit design and an oil supply method for lubricating wheel-end electric drive axles, and a dual-circuit oil pump.

A dual-circuit oil pump according to the present invention comprises: a motor; a first pump and a second pump, the first pump and the second pump having a common rotor shaft driven by the motor; and a seal mounted on the common rotor shaft, wherein the seal is configured to sealingly isolate the first pump from the second pump, such that an inlet of the first pump is sealingly isolated from an inlet of the second pump, and an outlet of the first pump is sealingly isolated from an outlet of the second pump.

According to the dual-circuit oil pump of the present invention, two separate oil circuits are formed by using the seal as described above. This structure will facilitate the formation of an independent circuit for each wheel-end electric drive system, will be easier to control the flow than an oil pump with two independent drives, and can save space and avoid interference.

Preferably, the seal is a mechanical seal. Due to the use of the mechanical sealing between two pump bodies, the loss is very small. More preferably, the seal is a centrifugal mechanical seal. More preferably, the seal is a centrifugal mechanical sealing ring (the number of centrifugal mechanical sealing rings may be 1, but is preferably 2). Compared with ordinary rubber sealing rings, the mechanical sealing ring can withstand greater pressure, so they have the advantages of less leakage and longer life. Therefore, it is preferable to use a mechanical sealing ring to ensure the independence of the two circuits and improve the oil supply efficiency.

Preferably, where the seal is a centrifugal mechanical seal, when the dual-circuit oil pump stops, an oil chamber of the first pump is allowed to communicate with an oil chamber of the second pump, so that there is a certain function of balancing the liquid levels in two zones. After the dual-circuit oil pump is started, under the action of centrifugal force, the seal expands and forms a dense oil film with an aperture, blocking most of the oil.

Preferably, a long-term operating pressure of the dual-circuit oil pump is between ⅓ and ½ of a maximum operating pressure of the dual-circuit oil pump.

Preferably, the motor is sealed from the common rotor shaft via a contact oil seal. This is to prevent the motor from coming into contact with oil. Preferably, considering the large friction loss and heat generation of the shaft seal, the number of contact oil seals is not greater than 3.

An oil circuit design for lubricating wheel-end electric drive axles according to the present invention comprises: the dual-circuit oil pump as described above; a first oil filter and a second oil filter; and a first heat exchanger and a second heat exchanger, wherein from a first housing, a lubricating oil flows into the first oil filter, flows into the dual-circuit oil pump after being filtered, is then pumped into the first heat exchanger and cooled, and finally flows back into the first housing, and a first wheel-end electric drive axle is received in the first housing; and wherein from a second housing, a lubricating oil flows into the second oil filter, flows into the dual-circuit oil pump after being filtered, is then pumped into the second heat exchanger and cooled, and finally flows back into the second housing, and a second wheel-end electric drive axle is received in the second housing.

Optionally, the first heat exchanger or the second heat exchanger is an oil cooler.

Optionally, a first wheel-end motor for driving a first wheel end is received in the first housing.

Optionally, a second wheel-end motor for driving a second wheel end is received in the second housing.

An oil supply method for lubricating wheel-end electric drive axles according to the present invention comprises: using the dual-circuit oil pump as described above to cause a lubricating oil from an oil inlet of a first side oil pool to pass through a first oil filter, then pumping the lubricating oil from the dual-circuit oil pump into a first heat exchanger for cooling, and finally dispensing the lubricating oil to a first wheel-end electric drive axle; and independently of the oil supply to the first wheel-end electric drive axle, using the dual-circuit oil pump to cause a lubricating oil from an oil inlet of a second side oil pool to pass through a second oil filter, then pumping the lubricating oil from the dual-circuit oil pump into a second heat exchanger for cooling, and finally dispensing the lubricating oil to a second wheel-end electric drive axle.

According to the oil circuit design and oil supply method for lubricating wheel-end electric drive axles and the dual-circuit oil pump of the present invention, two independent circuits are used to reduce the influence of the height difference between two ends on the flow when a commercial vehicle travels in a tilting condition, thereby ensuring that the amount of oil in each wheel-end electric drive system is within a reasonable range and reducing the power loss.

Further effects of the above non-conventional optional methods will be described below in conjunction with specific implementations.

### BRIEF DESCRIPTION OF THE DRAWINGS

The accompanying drawings are used to better understand the present invention and do not constitute an improper limitation of the present invention. In the drawings:

FIG. 1 is a schematic diagram showing the requirements for a tilting angle when a commercial vehicle travels in a tilting condition;

FIG. 2 is a schematic diagram of an oil circuit design for lubricating wheel-end electric drive axles according to an embodiment of the present invention;

FIG. 3 is a schematic diagram of a dual-circuit oil pump according to an embodiment of the present invention;

FIG. 4 is an internal cross-sectional view of a dual-circuit oil pump according to an embodiment of the present invention;

FIG. 5 is a partial enlarged view of the circled portion in FIG. 4, showing a seal for use in a dual-circuit oil pump according to an embodiment of the present invention; and

FIG. 6 is a simplified illustration of oil dispensing channels in FIG. 2.

### LIST OF REFERENCE SIGNS

1: Dual-circuit oil pump
2a: First oil filter
2b: Second oil filter
3a: First heat exchanger
3b: Second heat exchanger
4a: First housing
4b: Second housing
5a: First wheel-end motor
5b: Second wheel-end motor
6a: First wheel end
6b: Second wheel end
11: Motor
12a: First pump
12b: Second pump
13: Common rotor shaft
14: Seal
15a: Inlet of the first pump
15b: Inlet of the second pump
16a: Outlet of the first pump
16b: Outlet of the second pump

### DETAILED DESCRIPTION OF EMBODIMENTS

Exemplary embodiments of the present invention are described below with reference to the accompanying drawings. Various details of the embodiments of the present invention are included to facilitate understanding and should be considered exemplary only. Accordingly, it should be appreciated by those of ordinary skill in the art that various changes and modifications can be made to the embodiments described herein without departing from the scope and spirit of the present invention. Likewise, descriptions of well-known functions and structures are omitted from the following description for clarity and conciseness.

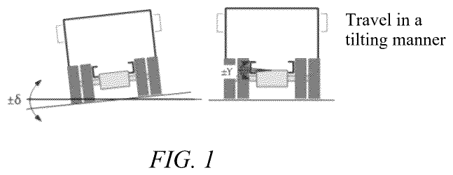

FIG. 1 is a schematic diagram showing the requirements for a tilting angle when a commercial vehicle travels in a tilting condition. In FIG. 1, an angle of δ represents the tilting angle of the road surface, and an angle of γ represents the tilting angle of an axle.

As shown in FIG. 1, when the commercial vehicle travels in a continuous tilting condition, it is expected to ensure the stability of lateral traveling under a restriction on the sum of the tilting angle δ of the road surface and the tilting angle γ of the axle. When the commercial vehicle travels in a short-term tilting condition, this restriction on the sum of the tilting angle δ of the road surface and the tilting angle γ of the axle can be temporarily relaxed.

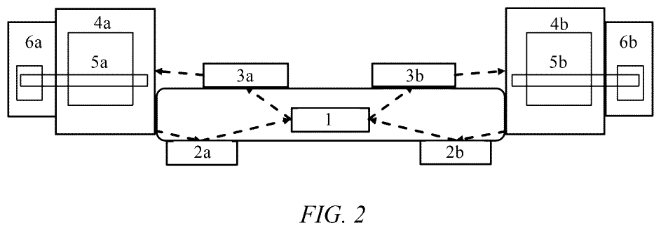

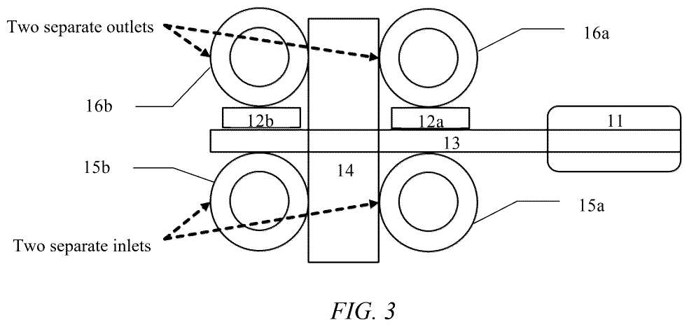

FIG. 2 is a schematic diagram of an oil circuit design for lubricating wheel-end electric drive axles according to an embodiment of the present invention. FIG. 2 shows the basic concept of the oil circuit design. The oil circuit design comprises: a dual-circuit oil pump 1 (see FIG. 3 for details); a small first oil filter 2a and second oil filter 2b; and a small first heat exchanger 3a and second heat exchanger 3b. From a first housing 4a, a lubricating oil flows into the first oil filter 2a, flows into the dual-circuit oil pump 1 after being filtered, is then pumped into the first heat exchanger 3a and cooled, and finally flows back into the first housing 4a, and a first wheel-end electric drive axle is received in the first housing 4a. From a second housing 4b, a lubricating oil flows into the second oil filter 2b, flows into the dual-circuit oil pump 1 after being filtered, is then pumped into the second heat exchanger 3b and cooled, and finally flows back into the second housing 4b, and a second wheel-end electric drive axle is received in the second housing 4b.

FIG. 3 is a schematic diagram of a dual-circuit oil pump according to an embodiment of the present invention. The dual-circuit oil pump 1 comprises two pumps (a first pump 12a and a second pump 12b) driven by the same motor 11, but the two pumps have separate oil circuits. This structure will facilitate the formation of an independent circuit for each wheel-end electric drive system, will be easier to control the flow than an oil pump with two independent drives, and can save space and avoid interference.

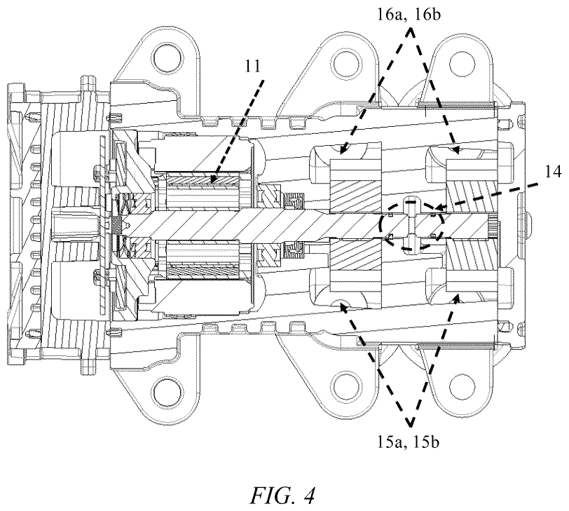

FIG. 4 is an internal cross-sectional view of a dual-circuit oil pump according to an embodiment of the present invention. Just like the previous introduction, the two pumps are driven by the same motor 11 and form two separate oil circuits by using the seal. Specifically, as shown in FIG. 3, the first pump 12a and the second pump 12b have a common rotor shaft 13 driven by the motor 11. A seal 14 is mounted on the common rotor shaft 13. The seal 14 is configured to sealingly isolate the first pump 12a from the second pump 12b, such that an inlet 15a of the first pump 12a is sealingly isolated from an inlet 15b of the second pump 12b, and an outlet 16a of the first pump 12a is sealingly isolated from an outlet 16b of the second pump 12b.

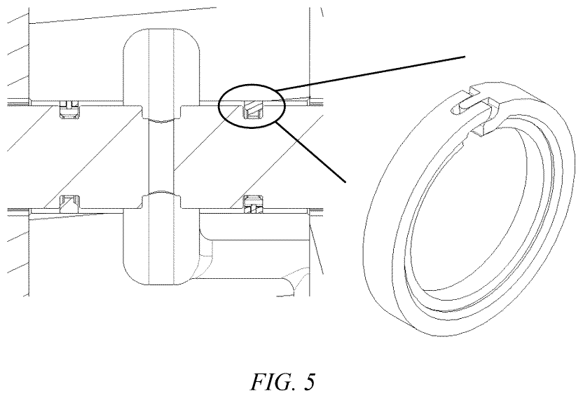

FIG. 5 is a partial enlarged view of the circled portion in FIG. 4, showing a seal for use in a dual-circuit oil pump according to an embodiment of the present invention. Preferably, the seal 14 is a mechanical seal. Due to the use of the mechanical sealing between two pump bodies, the loss is very small. More preferably, the seal 14 is a centrifugal mechanical seal. More preferably, the seal 14 is a centrifugal mechanical sealing ring (the number of centrifugal mechanical sealing rings may be 1, but is preferably 2). Although a centrifugal mechanical sealing ring is depicted in FIG. 5 for illustrative purposes only, those skilled in the art should understand that the type of the seal 14 does not have to be limited in principle, as long as two separate oil circuits can be formed by using the seal 14 as described above. Compared with ordinary rubber sealing rings, the mechanical sealing ring can withstand greater pressure, so they have the advantages of less leakage and longer life. Therefore, this design preferably uses a mechanical sealing ring to ensure the independence of the two circuits and improve the oil supply efficiency.

Where the seal 14 is a centrifugal mechanical seal, when the dual-circuit oil pump 1 stops, an oil chamber of the first pump 12a is allowed to communicate with an oil chamber of the second pump 12b, so that there is a certain function of balancing the liquid levels in two zones. After the dual-circuit oil pump 1 is started, under the action of centrifugal force, the seal 14 expands and forms a dense oil film with an aperture, blocking most of the oil.

Preferably, a long-term operating pressure of the dual-circuit oil pump 1 is between ⅓ and ½ of a maximum operating pressure of the dual-circuit oil pump 1.

Preferably, the motor 11 is sealed from the common rotor shaft 13 via a contact oil seal. This is to prevent the motor 11 from coming into contact with oil. Preferably, considering the large friction loss and heat generation of the shaft seal, the number of contact oil seals is not greater than 3.

Optionally, the first heat exchanger 3a or the second heat exchanger 3b is an oil cooler. Optionally, as shown in FIG. 2, a first wheel-end motor 5a for driving a first wheel end 6a is received in the first housing 4a.

Optionally, as shown in FIG. 2, a second wheel-end motor 5b for driving a second wheel end 6b is received in the second housing 4b.

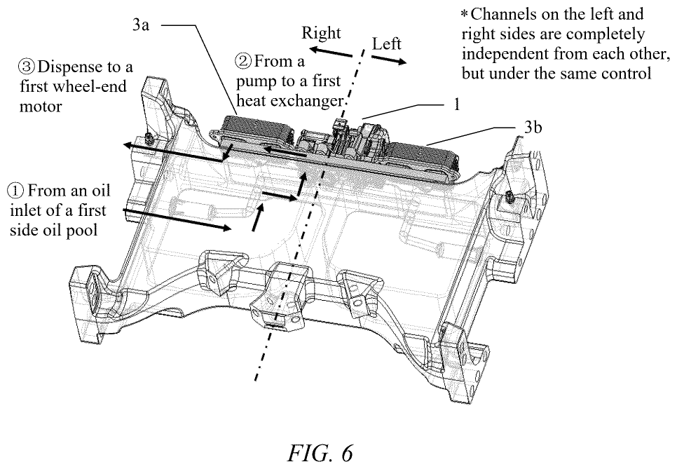

FIG. 6 is a simplified illustration of oil dispensing channels in FIG. 2. In FIG. 6, for the sake of simplicity and clarity, only the right-hand oil dispensing channel is shown. The oil dispensing channels on the left and right sides are completely independent from each other, but under the same control. Referring to FIGS. 2 and 6, an oil supply method for lubricating wheel-end electric drive axles according to the present invention comprises: using the dual-circuit oil pump 1 to cause a lubricating oil from an oil inlet of a first side oil pool to pass through a first oil filter 2a, then pumping the lubricating oil from the dual-circuit oil pump 1 into a first heat exchanger 3a for cooling, and finally dispensing the lubricating oil to a first wheel-end electric drive axle; and independently of the oil supply to the first wheel-end electric drive axle, using the dual-circuit oil pump 1 to cause a lubricating oil from an oil inlet of a second side oil pool to pass through a second oil filter 2b, then pumping the lubricating oil from the dual-circuit oil pump 1 into a second heat exchanger 3b for cooling, and finally dispensing the lubricating oil to a second wheel-end electric drive axle.

According to the oil circuit design and oil supply method for lubricating wheel-end electric drive axles and the dual-circuit oil pump of the present invention, two independent circuits are used to reduce the influence of the height difference between two ends on the flow when a commercial vehicle travels in a tilting condition as shown in FIG. 1, thereby ensuring that the amount of oil in each wheel-end electric drive system is within a reasonable range and reducing the power loss.

The above specific implementations do not constitute a limitation on the scope of the present invention. It should be appreciated by those skilled in the art that various modifications, combinations, sub-combinations and substitutions may be made depending on design requirements and other factors. Any modifications, equivalent substitutions, improvements, etc. made within the spirit and principles of the present invention shall fall into the scope of protection of the present invention.

1. A dual-circuit oil pump (1), comprising:
a motor (11);
a first pump (12a) and a second pump (12b), the first pump (12a) and the second pump (12b) having a common rotor shaft (13) driven by the motor (11); and
a seal (14) mounted on the common rotor shaft (13), wherein the seal (14) is configured to sealingly isolate the first pump (12a) from the second pump (12b), such that an inlet (15a) of the first pump (12a) is sealingly isolated from an inlet (15b) of the second pump (12b), and an outlet (16a) of the first pump (12a) is sealingly isolated from an outlet (16b) of the second pump (12b).

2. The dual-circuit oil pump (1) according to claim 1, wherein the seal (14) is a mechanical seal.

3. The dual-circuit oil pump (1) according to claim 2, wherein the seal (14) is a centrifugal mechanical seal.

4. The dual-circuit oil pump (1) according to claim 3, wherein the seal (14) is a centrifugal mechanical sealing ring.

5. The dual-circuit oil pump (1) according to claim 4, wherein the number of centrifugal mechanical sealing rings is 2.

6. The dual-circuit oil pump (1) according to claim 3, wherein when the dual-circuit oil pump (1) stops, an oil chamber of the first pump (12a) is allowed to communicate with an oil chamber of the second pump (12b).

7. The dual-circuit oil pump (1) according to claim 1, wherein a long-term operating pressure of the dual-circuit oil pump (1) is between ⅓ and ½ of a maximum operating pressure of the dual-circuit oil pump (1).

8. The dual-circuit oil pump (1) according to claim 1, wherein the motor (11) is sealed from the common rotor shaft (13) via a contact oil seal.

9. The dual-circuit oil pump (1) according to claim 8, wherein the number of contact oil seals is not greater than 3.

10. An oil circuit design for lubricating wheel-end electric drive axles, the oil circuit design comprising:
circuit oil pump (1) according to claim 1;
a first oil filter (2a) and a second oil filter (2b); and
a first heat exchanger (3a) and a second heat exchanger (3b),
wherein from a first housing (4a), a lubricating oil flows into the first oil filter (2a), flows into the dual-circuit oil pump (1) after being filtered, is then pumped into the first heat exchanger (3a) and cooled, and finally flows back into the first housing (4a), and a first wheel-end electric drive axle is received in the first housing (4a); and
wherein from a second housing (4b), a lubricating oil flows into the second oil filter (2b), flows into the dual-circuit oil pump (1) after being filtered, is then pumped into the second heat exchanger (3b) and cooled, and finally flows back into the second housing (4b), and a second wheel-end electric drive axle is received in the second housing (4b).

11. The oil circuit design for lubricating wheel-end electric drive axles according to claim 10, wherein the first heat exchanger (3a) or the second heat exchanger (3b) is an oil cooler.

12. The oil circuit design for lubricating wheel-end electric drive axles according to claim 10, wherein a first wheel-end motor (5a) for driving a first wheel end (6a) is received in the first housing (4a).

13. The oil circuit design for lubricating wheel-end electric drive axles according to claim 10, wherein a second wheel-end motor (5b) for driving a second wheel end (6b) is received in the second housing (4b).

14. An oil supply method for lubricating wheel-end electric drive axles, the oil supply method comprising:
using the dual-circuit oil pump (1) according to claim 1 to cause a lubricating oil from an oil inlet of a first side oil pool to pass through a first oil filter (2a), then pumping the lubricating oil from the dual-circuit oil pump (1) into a first heat exchanger (3a) for cooling, and finally dispensing the lubricating oil to a first wheel-end electric drive axle; and
independently of the oil supply to the first wheel-end electric drive axle, using the dual-circuit oil pump (1) to cause a lubricating oil from an oil inlet of a second side oil pool to pass through a second oil filter (2b), then pumping the lubricating oil from the dual-circuit oil pump (1) into a second heat exchanger (3b) for cooling, and finally dispensing the lubricating oil to a second wheel-end electric drive axle.
